(19) United States
(12) Patent Application Publication
(10) Pub. No.: US 2025/0139232 A1
(43) Pub. Date: May 1, 2025

(54) METHOD, APPARATUS, SYSTEM, AND COMPUTER PROGRAM FOR ENHANCING SECURITY OF HETEROGENEOUS OPERATING SYSTEM DEVICE

(71) Applicant: SAMSUNG SDS CO., LTD., Seoul (KR)

(72) Inventors: Joonhee LEE, Seoul (KR); Tae Young PARK, Seoul (KR)

(73) Assignee: SAMSUNG SDS CO., LTD., Seoul (KR)

(21) Appl. No.: 18/903,193

(22) Filed: Oct. 1, 2024

(30) Foreign Application Priority Data
Oct. 27, 2023 (KR) 10-2023-0145254

(51) Int. Cl. G06F 21/54; G06F 21/55; G06F 21/57

(52) U.S. Cl. CPC G06F 21/54; G06F 21/552; G06F 21/577

(57) ABSTRACT

The present disclosure relates to a method, an apparatus, a system, and a computer program for enhancing security of a heterogeneous operating system device and, more specifically, provides a security method for a computing apparatus in which a heterogeneous operating system is driven, the method including an operation of collecting, by a first security agent driven in a host OS of the computing apparatus, guest OS information for a guest OS installed on the host OS and an operation of performing, by the first security agent on the basis of the guest OS information, management for a second security agent driven on the guest OS.

### CROSS-REFERENCE TO RELATED APPLICATION(S)

This application is based on and claims priority under 35 U.S.C. 119 to Korean Patent Application No. 10-2023-0145254, filed on Oct. 27, 2023, in the Korean Intellectual Property Office, the disclosure of which is herein incorporated by reference in its entirety.

### BACKGROUND OF THE INVENTION

### 1. Field of the invention

The present disclosure relates to a method, an apparatus, a system, and a computer program for enhancing security of a heterogeneous operating system device and, more specifically, to a method, an apparatus, a system, and a computer program for enhancing security of a heterogeneous operating system device, which may enhance security of a device having a heterogeneous operating system, such as Linux, driven on a WSL of Windows.

### 2. Description of the Prior Art

In accordance with the increasing provision of various on-line services on the basis of wired and wireless communication networks, the importance of security continues to grow, and as a result, various security techniques are being implemented.

More specifically, in companies and research institutes, in order to prevent unauthorized leakage of internal information, security applications are installed on Windows or Linux-based PCs, laptops, smartphones, and the like employing techniques such as process hooking or active directory to prevent leakage of information to the outside through external apparatuses or networks.

However, the aforementioned legacy techniques may have security flaws with respect to devices in which a heterogeneous operating system, such as a Linux system which is driven on the Windows subsystem for Linux (WSL) provided from Windows operating system (OS), is driven.

More specifically, in case of devices driving Linux on the WSL, a process of the Linux operates without using drivers or the like provided by Windows, and thus it may be difficult for security applications installed on Windows to detect or respond to information leakage activities conducted on Linux.

To address this, when a Windows security application controls WSL-related processes to prevent information leakage in Linux, it may result in restricting services for users who are not involved in any security issues.

Consequently, there is an increasing demand for an effective solution to address security issues that may arise on devices in which a heterogeneous operating system is driven, but a proper solution has yet to be proposed.

### SUMMARY OF THE INVENTION

To address the above-mentioned deficiencies, an aspect of the present disclosure is to provide a method, an apparatus, a system, and a computer program for enhancing security of a heterogeneous operating system device, which may effectively enhance security of a device driven on the basis of a heterogeneous operating system.

In addition, an aspect of the present disclosure is to provide a method, an apparatus, a system, and a computer program for enhancing security of a heterogeneous operating system device, which may apply a security policy applied to a host operation system in a device driven with a heterogeneous operating identically to a guest operating system.

In addition, an aspect of the present disclosure is to provide a method, an apparatus, a system, and a computer program for enhancing security of a heterogeneous operating system device, which may allow a first security agent driving in a host operation system of a device driven with a heterogeneous operation system to manage a second security agent operating in a guest operation system and, if necessary, to automatically install or re-operate the second security agent.

The technical problems addressed by the present disclosure are not limited to the above technical problems and other technical issues not specified will be readily understood by those skilled in the art, to which the present disclosure pertains, from the content of the present disclosure.

A first aspect of the present disclosure relates to a security method of a computing apparatus in which a heterogeneous operating system drives, the method including an operation of collecting, by a first security agent driven in a host OS of the computing apparatus, guest OS information for a guest OS installed on the host OS and an operation of performing, by the first security agent on the basis of the guest OS information, management for a second security agent driven on the guest OS.

Here, the operation of performing management may include an operation of receiving, by the first security agent, a periodic signal periodically transmitted from the second security agent and an operation of performing, by the first security agent in case that the periodic signal is not received, a predetermined security operation for the guest OS.

In addition, in the operation of performing the security operation, installation of the second security agent or re-execution of the second security agent may be performed.

Here, the operation of performing the security operation may include an operation of identifying a normal installation state verification history with respect to the second security agent, an operation of installing the second security agent in case that there is a normal installation state verification history of the second security agent and verifying a normal installation state of the second security agent in case that there is no normal installation state verification history of the second security agent, and an operation of re-executing the second security agent in case that the second security agent is normally installed or installing the second security agent in case that the second security agent is not normally installed.

Furthermore, the operation of performing management may include an operation of receiving, by the first security agent, second security log data for the guest OS transmitted by the second security agent, and an operation of generating, integrated security log data on the basis of the second security log data and the first security log data for the host OS, and transmitting the generated integrated security log data to the security sever, by the first security agent.

In addition, the second security agent may receive and apply a security policy identical to a security policy applied to the first security agent.

In addition, the first security agent may perform a security process based on the host OS with respect to at least one information input/output apparatus provided to the computing apparatus and the second security agent may perform a security process based on the guest OS with respect to the at least one information input/output apparatus.

Here, the host OS may correspond to a Windows OS, the guest OS may correspond to a Linux OS driven on the WSL of the Windows OS, and the first security agent may perform management for the second security agent using an interface or a file sharing protocol provided by the WSL.

In addition, the second security agent may detect a mounting state change in the Linux OS using a mounting information file of the Linux OS and perform a security process based on a security policy on the basis of the detected mounting state change.

In addition, the second security agent may receive a security policy file from the first security agent using a file sharing protocol provided by the WSL and apply the security policy file.

Furthermore, a second aspect of the present disclosure relates to a computing apparatus including a processor and a memory and performing security with respect to an environment in which a heterogeneous operating system is driven, wherein the memory may include an instruction configured to, when executed by the processor, cause the server to implement a predetermined operation, and the predetermined operation may include collecting, by a first security agent driven in a host OS, guest OS information for a guest OS installed on the host OS and performing, by the first security agent on the basis of the guest OS information, management for a second security agent driven on the guest OS.

Here, the performing of management may include receiving, by the first security agent, a periodic signal periodically transmitted from the second security agent and performing, by the first security agent in case that the periodic signal is not received, a predetermined security operation for the guest OS.

Here, the performing of the security operation may include identifying a normal installation state verification history with respect to the second security agent, installing the second security agent in case that there is a normal installation state verification history of the second security agent and verifying a normal installation state of the second security agent in case that there is no normal installation state verification history of the second security agent, and re-executing the second security agent in case that the second security agent is normally installed or installing the second security agent in case that the second security agent is not normally installed.

Furthermore, the performing of management may include receiving, by the first security agent, second security log data for the guest OS transmitted by the second security agent, and generating integrated security log data to transmitted to the security server, on the basis of the second security log data, and the first security log data for the host OS, by the first security agent.

In addition, the second security agent may receive and apply a security policy identical to a security policy applied to the first security agent.

In addition, the first security agent may perform a security process based on the host OS with respect to at least one information input/output apparatus provided to the computing apparatus and the second security agent may perform a security process based on the guest OS with respect to the at least one information input/output apparatus.

Here, the host OS may correspond to a Windows OS, the guest OS may correspond to a Linux OS driven on the WSL of the Windows OS, and the first security agent may perform management for the second security agent using an interface or a file sharing protocol provided by the WSL.

In addition, the second security agent may detect a mounting state change in the Linux OS using a mounting information file of the Linux OS and perform a security process based on a security policy on the basis of the detected mounting state change.

In addition, the second security agent may receive a security policy file from the first security agent using a file sharing protocol provided by the WSL and apply the security policy file.

Furthermore, a third aspect of the present disclosure relates to a computer-readable storage medium storing instructions configured to, when executed by a processor, cause a computing apparatus to perform a predetermined operation, the computing apparatus including the processor and being configured to perform security with respect to an environment in which a heterogeneous operating system is driven, wherein the predetermined operation may include collecting, by a first security agent driven in a host OS, guest OS information for a guest OS installed on the host OS and performing, by the first security agent on the basis of the guest OS information, management for a second security agent driven on the guest OS.

As such, the method, the apparatus, the system, and the computer program for enhancing security of a heterogeneous operating system device according to an embodiment of the present disclosure may allow efficient security enhancement of a device driven on the basis of the heterogeneous operating system.

Furthermore, the method, the apparatus, the system, and the computer program for enhancing security of a heterogeneous operating system device according to an embodiment of the present disclosure may allow a security policy, which is identical to a security policy applied to a host operating system of a device driven with a heterogeneous operating system, to be applied to a guest operating system.

Furthermore, the method, the apparatus, the system, and the computer program for enhancing security of a heterogeneous operating system device according to an embodiment of the present disclosure may allow a first security agent driven on a host operating system of a device driven with a heterogeneous operating system to manage a second security driven system operating on a guest operating system and, if necessary, to automatically install or re-execute the second security agent.

The effects achievable by the present disclosure are not limited to the above effects and other effects not specified will be readily understood by those skilled in the art, to which the present disclosure pertains, from the content of the present disclosure.

### BRIEF DESCRIPTION OF THE DRAWINGS

In order to help understanding of the present disclosure, the accompanying drawings which are included as a portion of the detailed description provide embodiments of the present disclosure and are provided to describe the technical features of the present disclosure together with the detailed description.

FIG. 1 is a view illustrating a configuration of a heterogeneous operating system device security system importance assessment system according to an embodiment of the present disclosure.

FIG. 2 is a flowchart illustrating a security method for a heterogeneous operating system device according to an embodiment of the disclosure.

FIG. 3 is a view illustrating a detailed configuration and operation of a heterogeneous operating system device security system according to an embodiment of the present disclosure.

FIGS. 4 to 6 are views illustrating a detailed flowchart of a security method for a heterogeneous operating system device according to an embodiment of the disclosure.

FIG. 7 is a view illustrating a detailed configuration and operation of a heterogeneous operating system device according to an embodiment of the present disclosure.

FIG. 8 is a view illustrating a detailed flowchart of a security method for a heterogeneous operating system device according to an embodiment of the disclosure.

FIGS. 9 to 12 are views illustrating a detailed operation of a security method for a heterogeneous operating system device according to an embodiment of the disclosure.

FIG. 13 is a view illustrating a configuration of a computing apparatus configured to perform security for a heterogeneous operating system environment according to an embodiment of the present disclosure.

### DETAILED DESCRIPTION OF THE EXEMPLARY EMBODIMENTS

Hereinafter, various embodiments of the present disclosure will be described in detail with reference to accompanying drawings. The objects, specific advantages and novel features of the present disclosure will become more apparent from the following detailed description and preferred embodiments taken in conjunction with the accompanying drawings.

Prior to the description, the terms or words used in the present specification and claims should be construed as meanings and concepts consistent with the technical spirit of the present disclosure as the inventor has appropriately defined the concept in order to best explain the disclosure. They are for illustrative purposes only, and should not be construed as limiting the present invention.

In assigning reference numerals to the components, the same or similar components are given the same reference numerals regardless of the reference numerals, and redundant description thereof will be omitted. Herein, the terms “module” and “unit” for the elements used in the following description are given or used in common by considering facilitation in writing this disclosure only but fail to have meanings or roles discriminated from each other, and may be referred as software or hardware elements.

In describing elements of the present disclosure, when an element is expressed in a singular form, it should be understood that the element also includes a plural form unless otherwise specified. As used herein, terms such as “first” and “second” may be used to simply distinguish a corresponding component from another, and does not limit the components in other aspect. When it is described that one element is connected to another element, it means that still another element may be connected between the element and the another element.

In the following description of the disclosure, a detailed description of related prior art incorporated herein will be omitted when it is determined that the description may make the subject matter of embodiments disclosed in the disclosure unclear. The accompanying drawings are only for easy understanding of the embodiments disclosed in the present specification, and the technical ideas disclosed in the present specification are not limited by the accompanying drawings and it should be understood to include all modifications, equivalents and substitutes included in the spirit and scope of the present disclosure.

Hereinafter, exemplified embodiments of the method, the apparatus, the system, and the computer program for enhancing security of a heterogeneous operating system device will be described with reference to the accompanying drawings.

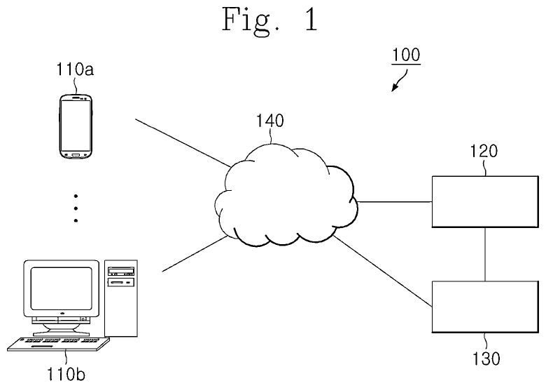

First, FIG. 1 illustrates a configuration and operation of a heterogeneous operating system device security system 100 according to an embodiment of the present disclosure. As shown in FIG. 1, the heterogeneous operating system device security system 100 according to an embodiment of the present disclosure may include a heterogeneous operating system device 120 configured to transfer information to the outside through a network drive or the like on the basis of a network 140 with respect to at least one device 110, or transfer information inside a company or organization to the outside through a portable storage device, such as a USB memory, and a security server 130 configured to manage security for the heterogeneous operating system device 120, such as providing a security policy for the heterogeneous operating system device 120 or receiving and analyzing security-related log information generated in the heterogeneous operating system device 120 or the like.

Here, with respect to the device 110, various devices that may receive predetermined information from the heterogeneous operating system device 120 through the network 140, such as a personal computer (PC), a laptop PC, a tablet PC, a smartphone, a PDA, and a server, may be used as the device 110.

In addition, the heterogeneous operating system device 120 corresponds to a device in which multiple different types of operating systems are driven, may be realized in various forms, such as a personal computer (PC), a laptop PC, a tablet PC, a smartphone, a PDA, and a server, and may include storage equipment, such as a database or a file storage.

More specifically, the heterogeneous operating system device 120 may include a Linux operating system which corresponds to a guest operating system (guest OS) driven on the Windows subsystem for Linux (WSL) provided by the Windows operating system (Windows OS) corresponding to a host operating system (host OS), but without limitation thereto, the present disclosure may be realized in various forms, such as a Windows operating system driven on the basis of a virtual machine (VM) or the like on a Linux operating system corresponding to a host operating system.

In addition, the security server 130 may be realized by using one or more physical server apparatuses, but without limitation thereto, the present disclosure may be realized using a personal computer processing device such as a desktop a computer, laptop, a tablet, and a smartphone, realized on the basis of a cloud system, or realized in various forms such as a dedicated apparatus.

In addition, in FIG. 1, the network 140 configured to connect the at least one device 110, the heterogeneous operation system device 120, and the security server 130 may use a wired network and wireless network and, more specifically, may include various communication networks, such as a local area network (LAN), a metropolitan area network (MAN), and wide area network (WAN). In addition, the network 140 may include the well-known World Wide Web (WWW). Furthermore, the network 140 may be realized using a data bus or the like configured to transmit or receive data or the like.

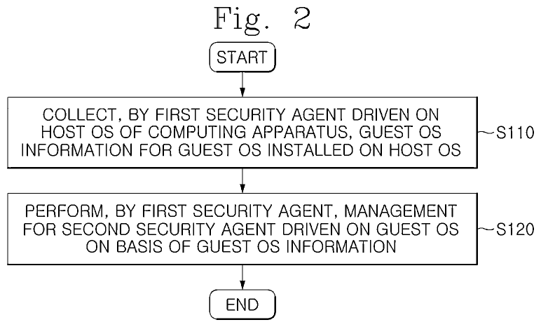

In addition, FIG. 2 illustrates a flowchart of a security method for the heterogeneous operating system device 120 according to an embodiment of the disclosure.

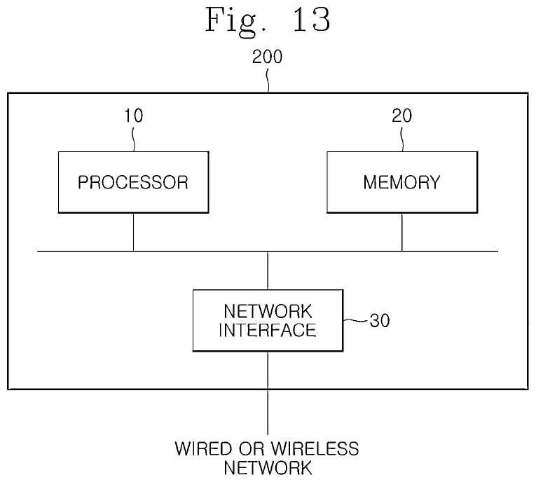

Here, the method shown in FIG. 2 may be performed by, for example, the heterogeneous operating system device 120 and the heterogeneous operating system device 120 may include a computing apparatus 200 in FIG. 13 and in a description described below with reference to FIG. 13. For example, the heterogeneous operating system device 120 may include a processor 10, and the processor 10 may perform work assignment by performing instructions configured to implement an operation for performing work allocation.

More specifically, as shown in FIG. 2, the security method according to an embodiment or the present disclosure for the heterogeneous operating system device 120 pertains to a security method for the computing apparatus 200 in which a heterogeneous operating system is driven and may include an operation S110 of collecting, by a first security agent 1211 driven on a host OS 121 of the computing apparatus 200, guest OS information for a guest OS 122 installed on the host OS 121 and an operation S120 of performing, by the first security agent 1211 on the basis of the guest OS information, management for a second security agent 1221 driven on the guest OS 122.

Here, the operation S120 of performing management may include an operation S121 of receiving, by the first security agent 1211, a periodic signal periodically transmitted from the second security agent 1221 and an operation S122 of performing, by the first security agent 1211 in case that the periodic signal is not received, a predetermined security operation for the guest OS 122.

In addition, in the operation S122 of performing the security operation, installation of the second security agent 1221 or re-execution of the second security agent 1221 may be performed.

Here, the operation S122 of performing the security operation may include an operation S1221 of identifying a normal installation state verification history with respect to the second security agent 1221, an operation S1222 of installing the second security agent 1221 in case that there is a normal installation state verification history of the second security agent 1221 and verifying a normal installation state of the second security agent 1221 in case that there is no normal installation state verification history of the second security agent 1221, and an operation S1223 of re-executing the second security agent 1221 in case that the second security agent 1221 is normally installed or installing the second security agent 1221 in case that the second security agent 1221 is not normally installed.

Furthermore, the operation S120 of performing management may include an operation S123 of receiving, by the first security agent 1211, second security log data for the guest OS 122 transmitted by the second security agent 1221, and an operation S124 of generating integrated security log data, on the basis of the second security log data and the first security log data for the host OS 121, and transmitting the generated integrated security log data to the security server 130, by the first security agent 1211.

In addition, the second security agent 1221 may receive and apply a security policy identical to a security policy applied to the first security agent 1211.

In addition, the first security agent 1211 may perform a security process based on the host OS 121 with respect to at least one information input/output apparatus provided to the computing apparatus 200 and the second security agent 1221 may perform a security process based on the guest OS 122 with respect to the at least one information input/output apparatus.

Here, the host OS 121 may correspond to a Windows OS, the guest OS 122 may correspond to a Linux OS driven on the WSL of the Windows OS, and the first security agent 1211 may perform management for the second security agent 1221 using an interface or a file sharing protocol provided by the WSL.

In addition, the second security agent 1221 may detect a mounting state change in the Linux OS using a mounting information file of the Linux OS and perform a security process based on a security policy on the basis of the detected mounting state change.

In addition, the second security agent 1221 may receive a security policy file from the first security agent 1211 using a file sharing protocol provided by the WSL and apply the security policy file.

Accordingly, the method, the apparatus, the system, and the computer program for enhancing security of a heterogeneous operating system device according to an embodiment of the present disclosure may allow efficient security enhancement of the device driven on the basis of the heterogeneous operating system, allow a security policy, which is identical to a security policy applied to the host operating system 121, to be applied to the guest operating system 122, and allow the first security agent 1211 driven on the host operating system 121 to manage the second security agent 1221 driven on the guest operating system 122, and, if necessary, to automatically install or re-execute the second security agent 1221.

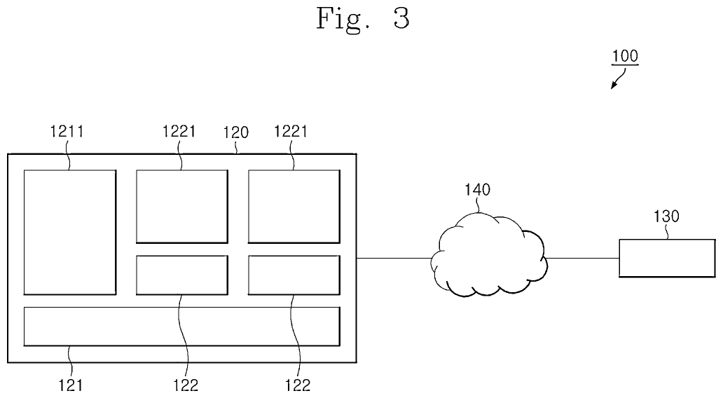

In addition, FIG. 3 illustrates a detailed configuration and operation of a heterogeneous operating system device security system 100 according to an embodiment of the present disclosure.

Hereinafter, a security method, apparatus, and system for a heterogeneous operating system device according to an embodiment of the disclosure will be described in detail with reference to FIGS. 1 to 3.

First, in operation S110, the first security agent 1211 driven on the host OS 121 of the computing apparatus 200, such as the heterogeneous operating system device 120, collects guest OS information with respect to the guest OS 122 installed on the host OS 121.

More specifically, as shown in FIG. 3, the heterogeneous operating system device 120 may include the first security agent 1211 driven on the host OS 121.

For example, in case that the host OS 121 is a Windows OS, the first security agent 1211 may be realized as an application or the like for the Windows OS and may manage security for the heterogeneous operating system device 120 when a user of the heterogeneous operating system device 120 attempts to store a file in a portable storage apparatus, such as a network drive or a USB memory, in the Windows OS environment, by determining and controlling whether to permit on the basis of a security policy provided from the security server 130 and the like or generating log information related thereto.

Here, as shown in FIG. 3, at least one guest OS 122 having a different type from the host OS 121 may be installed on the host OS 121.

For example, in case that the host OS 121 is a Windows OS, a Linux OS as the guest OS 122 may be installed on the Windows Subsystem for Linux (WSL) provided from the Windows OS.

Furthermore, as shown in FIG. 3, it is also possible that a first guest OS 122 having a different type from the host OS 121 and a second guest OS 122 having a different type are installed on the host OS 121.

Here, the guest OS 122 may perform controlling for the heterogeneous operating system device 120 independently from the host OS 121 and even when the user of the heterogeneous operating system device 120 tries to store information on a network drive, a portable storage apparatus, or the like in an environment of the guest OS 122, the first security agent 1211 driven on the host OS 121 may not detect the process and notify same, thus incurring a problem.

Accordingly, in the present disclosure, the first security agent 1211 may perform an operation for managing security for the guest OS 122 by collecting guest OS information for the guest OS 122 installed on the host OS 121 and installing the second security agent 1221 capable of managing security for the guest OS 122 on the basis of the collected information.

More specifically, the first security agent 1211 may collect information, as the guest OS information for the guest OS 122, such as a type of the guest OS 122, a version of the guest OS 122, and whether the second security agent 1221 is installed on the guest OS 122, but the present disclosure is not limited thereto.

Accordingly, in operation 120, on the basis of the guest OS information, the first security agent 1211 may perform management for the second security agent 1221 driven on the guest OS 122.

More specifically, for example, the first security agent 1211 may install the second security agent 1221 with reference to the type of the guest OS 122, the version of the guest OS 122, and the like when the second security agent 1221 is not installed on the guest OS 122, and may perform management for the second security agent 1221 by selecting a communication protocol for communication with the second security agent 1221 with reference to the type of the guest OS 122, the version of the guest OS 122, and the like when the second security agent 1221 is installed on the guest OS 122.

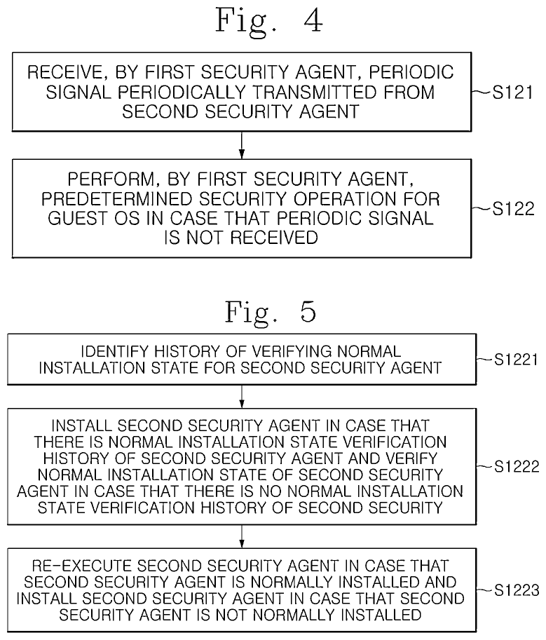

Here, as shown in FIG. 4, operation S120 may include an operation S121 of receiving, by the first security agent 1211, a periodic signal periodically transmitted from the second security agent 1221 and an operation S122 of performing, by the first security agent 1211 in case that the periodic signal is not received, a predetermined security operation for the guest OS 122.

More specifically, in operation S121, the first security agent 1211 may receive heartbeat signal transmitted by the second security agent 1221 according to a predetermined cycle and determine installation and a normal operation of the second security agent 1221.

Here, in operation S122, in case that no periodic signal like the heartbeat signal transmitted by the second security agent 1221 is received for a predetermined time period, the first security agent 1211 may perform verification of the second security agent 1221 or a re-installation or re-driving operation of the second security agent 1221.

In addition, as shown in FIG. 5, operation S122 may include an operation S1221 of identifying a normal installation state verification history with respect to the second security agent 1221, an operation S1222 of installing the second security agent 1221 in case that there is a normal installation state verification history of the second security agent 1221 and verifying a normal installation state of the second security agent 1221 in case that there is no normal installation state verification history of the second security agent 1221, and an operation S1223 of re-executing the second security agent 1221 in case that the second security agent 1221 is normally installed or installing the second security agent 1221 in case that the second security agent 1221 is not normally installed.

More specifically, in operation S1221, a history of verifying a normal installation state with respect to the second security agent 1221 may be identified.

Accordingly, in operation S1222, in case that there is a history of verifying a normal installation state of the second security agent 1221, it is determined that although the second security agent 1221 was installed normally, but changed to be in a state in which a normal operation is not possible at a current timepoint, so as to be unable to transmit a periodic signal like a heartbeat signal, and therefore the second security agent 1221 is reinstalled.

Meanwhile, in case that there is no history of verifying a normal installation n state of the second security agent 1221, a process for verifying a normal installation state of the second security agent 1221 is performed.

Accordingly, in operation S1223, as a result of the verification, if it is determined that the second security agent 1221 is installed normally, it is determined that a periodic signal such as a heartbeat signal may not be transmitted even though the second security agent is installed normally, and the second security agent 1221 is re-executed.

Meanwhile, if it is determined that the second security agent 1221 is not installed normally, a process for re-installing the second security agent 1221 is performed.

Accordingly, in the present disclosure, the first security agent 1211 may determine whether the second security agent 1221 is installed and operating normally and may efficiently perform security for the guest OS 122 through the operation of re-installing or re-executing the second security agent 1221.

Here, the second security agent 1221 may receive a security policy identical to a security policy applied to the first security agent 1211 and cause same to be applied thereto, and through this, security may be performed according to the identical security policy for both the first security agent 1211 and the second security agent 1221.

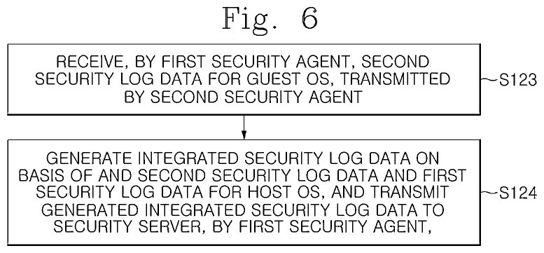

Furthermore, as shown in FIG. 6, operation S120 may include an operation S123 of receiving, by the first security agent 1211, second security log data 320b for the guest OS 122 transmitted by the second security agent 1221, and an operation S124 of generating integrated security log data 320, on the basis of the second security log data 320b and the first security log data 320a for the host OS 121, and transmitting the generated integrated security log data 320 to the security server 130, by the first security agent 1211.

specifically, in operation S123, the first security agent 1211 may receive the second security log data 320b for the guest OS 122 by using a 9p protocol which allows sharing of a file and the like by the second security agent 1221 between the host OS 121 and the guest OS 122.

Accordingly, in operation S124, the first security agent 1211 may generate integrated security log data 320 according to a predetermined specification by adjusting a format of a log file according to a difference in an operating environment, such as a heterogeneous operating system on the basis of the second security log data 320b and the first security log data 320a for the host OS 121 and transmit the integrated security log data to the security server 130, and the security server 130 may verify a security state for the host OS 121 and the guest OS 122 on the basis of the transmitted integrated security log data 320 and perform efficient security management for the heterogeneous operating system device 120 through, if necessary, a method of changing the security policy.

Accordingly, in the present disclosure, the first security agent 1211 performs a security process based on the host OS 121 with respect to at least one information input/output apparatus (e.g., a network drive, a portable storage medium, or the like) provided in the computing apparatus 200, such as the heterogeneous operating system device 120 and the second security agent 1221 concurrently performs a security process based on the guest OS 122 with respect to the at least one information input/output apparatus so as to perform efficient security management for the heterogeneous operating system device 120 in which the guest OS 122 is driven on the host OS 121.

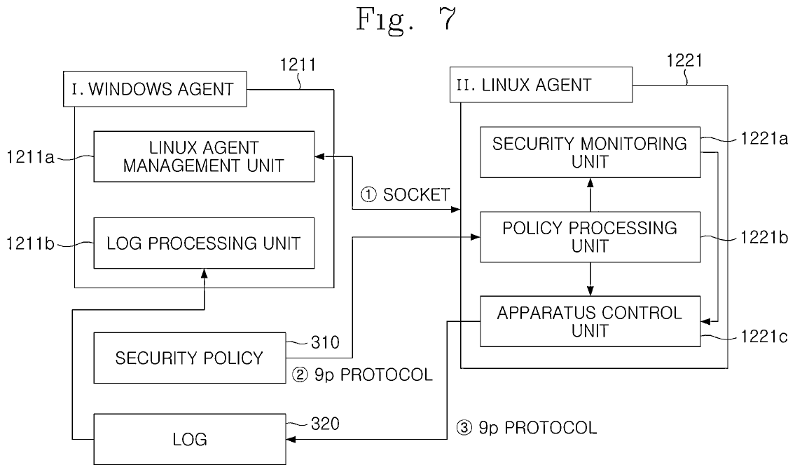

In this regard, FIG. 7 illustrates a case that in the computing apparatus 200, such as the heterogeneous operating system device 120, a Windows OS is driven as the host OS 121 and a Linux OS is driven as the guest OS 122 on the WSL provided by the Windows OS.

Hereinafter, referring to FIG. 7, a case that the Linux OS is driven on the WSL of the Windows OS is described, but the present disclosure is not limited thereto and may be applicable to various cases.

Here, as shown in FIG. 7, in the computing apparatus 200, such as the heterogeneous operating system device 120, a Windows agent corresponding to the first security agent 1211 responsible for security in the Windows OS which is the host OS 121 and a Linux agent corresponding to the second security agent 1221 responsible for security for the Linux OS which is the guest OS 122 installed on the WSL provided by the Windows OS may be driven.

Here, the Windows agent may serve as a Windows OS side driving module in a security program to prevent information leakage from the Windows OS, and when an abnormal activity attempt, such as access to an external apparatus, and file copying or deletion, occurs, may detect the occurrence and perform an operation such as preemptively blocking the abnormal activity according to a control policy, and generating and transmitting security log.

However, the Windows agent may not drive on the Linux OS due to a difference in OS structure or the like, and thus in order to prevent information leakage in the Linux OS by using a Linux agent driven on the Linux OS installed on the WSL of the Windows OS, the present disclosure may additionally add a configuration, such as a Linux agent management unit 1211a and a log processing unit 1211b, to the Windows agent.

Here, the Linux agent management unit 1211a may collect information related to a list of at least one Linux OS installed on the WSL, receive a heartbeat signal transmitted by the Linux agent to identify whether a Linux agent is installed, and when it is identified that a Linux agent is not installed on the Linux OS, automatically perform installation of the Linux agent.

In addition, the log processing unit 1211b may receive and process a second security agent log file 320b generated when the Linux agent performs monitoring and control activities.

In addition, the Linux agent may perform control and log operations according to the security policy by detecting change while monitoring mounting information of the Linux OS to manage security for the Linux OS.

More specifically, a security monitoring unit 1221a of the Linux agent may monitor a mounting information file linked to a kernel of the Linux OS according to the security policy and when a change is detected, transfer a mounting change to an apparatus control unit 1221c.

In this regard, a security policy 310 applied to the Windows agent may be received by a policy processing unit 1221b, processed so as to be applied to the Linux agent and loaded in a memory or the like, and provided to the security monitoring unit 1221a and the apparatus control unit 1221c.

Accordingly, the apparatus control unit 1221c may identify the mounting change detected by the security monitoring unit 1221a and perform the control and log operation according to the security policy.

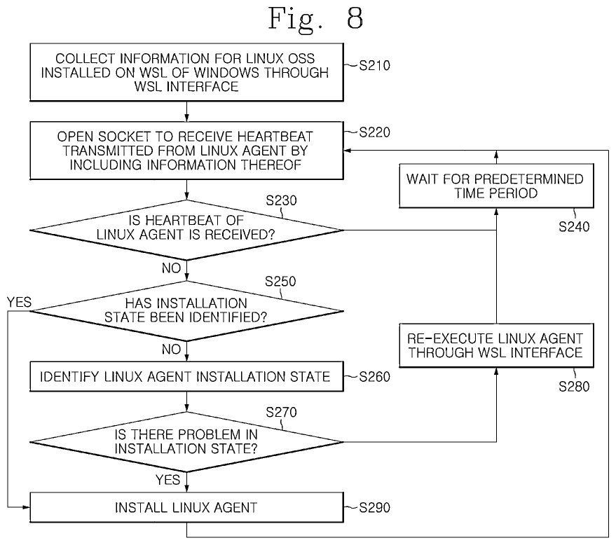

In this regard, FIG. 8 shows a flowchart illustrating a process of performing, by the Windows agent corresponding to the first security agent 1211, management of the Linux agent corresponding to the second security agent 1221 in the computing apparatus 200, such as the heterogeneous operating system device 120.

As shown in FIG. 8, the Windows agent collects information for Linux OSs installed on the WSL of the Windows OS through a WSL interface (S210).

Here, the Windows agent may collect a list of the Linux OSs installed on the WSL by using a WSL interface and information thereof.

Furthermore, the Windows OS and the Linux OS may access each other's file systems using the 9p protocol on the basis of the WSL of the Windows OS, and thus it is possible that the Windows agent investigates whether Linux agent files are normal and furthermore, execute a Linux agent installation file of the Windows OS to install the Linux agent on the Linus OS.

Thereafter, the Windows agent may receive a heartbeat signal transmitted by the Linux agent through socket communication or the like (S220).

More specifically, the Windows agent may open a socket communication channel and receive a heartbeat signal which the Linux agent of each Linux OS transmits, including information thereof.

Here, in case that the heartbeat signal is received (S230), the Windows agent waits for a predetermined unit of time and identifies heartbeat signals periodically received from the Linux agent while receiving the heartbeat signal (S240).

Meanwhile, in case that the Windows agent does not receive the heartbeat signal, the Windows agent identifies whether there is a history of verifying a normal installation state for the Linux agent (S250).

Here, in case that there is a history of verifying a normal installation state for the Linux agent, it is determined that although the Linux agent was installed normally, but changed to be in a state in which normal operation is not possible at a current timepoint, so as to be unable to transmit a periodic signal like a heartbeat signal, and thus, the Linux agent is reinstalled (S290).

Meanwhile, in case that there is no history of verifying a normal installation state of the Linux agent, a process of verifying a normal installation state of the Linux agent is performed (S260).

More specifically, the Windows agent may directly access a file system of each Linux OS and investigate file attributes, such as existence of files, execution authority of each file, and the like, for normal operation of a Linux agent with respect to a Linux OS which has not received the heartbeat signal, a checksum for a file content, and the like, so as to identify whether normal installation has been performed.

Accordingly, when it is determined that the Linux agent is normally installed, on the basis of a verification result (S270), it is determined that a periodic signal such as a heartbeat signal may not be transmitted even though the Linux agent is installed normally, and the Linux agent is re-executed through a WSL interface and the like (S280).

Meanwhile, when it is determined that the Linux agent is not installed normally, a process of re-installing the Linux agent is performed by executing a Linux agent installation file located in a file system of the Windows OS through a WSL interface and the like (S290).

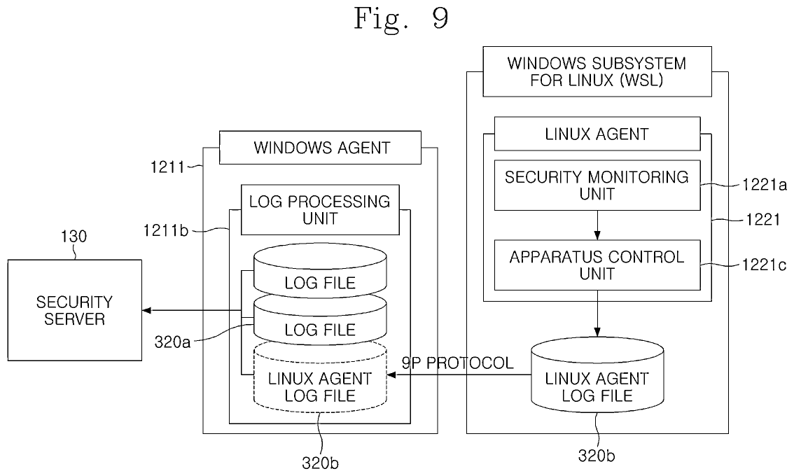

In addition, FIG. 9 illustrates a process of processing, by the Windows agent corresponding to the first security agent 1211, the log file 320 generated in the Linux agent corresponding to the second security agent 1221 in the computing apparatus 200, such as the heterogeneous operating system device 120.

Here, as shown in FIG. 9, the log processing unit 1211b of the Windows agent may collect and process the second security agent log file 320b, such as a Linux agent log file generated by the Linux agent through a monitoring and control activity, and then transmit the second security agent log file 320b to the security server 130. Here, the log processing unit 1211b may directly access and collect a Linux agent log file generated in the Linux agent without additional configuration, by using a shared file system automatically generated between the Linux OS and the Windows OS when the WSL is driven.

In addition, the apparatus control unit 1221c of the Linux agent may record, in the Linux agent log file 320b, log generation target information among the mounting change information transferred from the security monitoring unit 1221a and record, in the Linux agent log file 320b, information for occurrence of control with respect to an apparatus according to a control policy.

Accordingly, the log processing unit 1211b may generate the Linux agent log file 320b together with the log file 320a of the Windows agent, generate the integrated log file 320 by reflecting whether there has been a change, and transfer the integrated log file 320 to the security server 130.

In addition, in order for the Linux OS to access an external storage apparatus or network shared directory, the apparatus or path needs to be mounted to a root file system, and information about the mounting is provided by the Linux kernel in the form of “/proc/mounts” file.

Accordingly, the security monitoring unit 1221a monitors whether a change has occurred in the mounting-related file and in case that a change is detected, determine whether an apparatus may leak information to the outside, on the basis of a content of each mounting information item of the file.

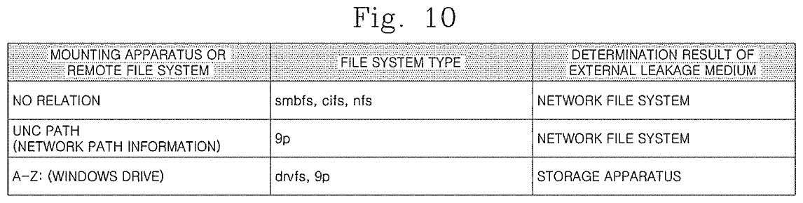

More specifically, referring to FIG. 10, it may be determined whether a mounted file system corresponds to a medium which may leak data to the outside, on the basis of mounting apparatus (or remote file system) information corresponding to a first field of “/proc/mounts”, a file system type corresponding to a second field.

In addition, a mounting option corresponding to a third field of “/proc/mounts” may indicate a user's read/write authority when a storage apparatus or network path is mounted as a file system and may be transferred to the apparatus control unit 1221c together with the mounting-related information so as to be utilized to determine a control level for the corresponding file system by reflecting the security policy.

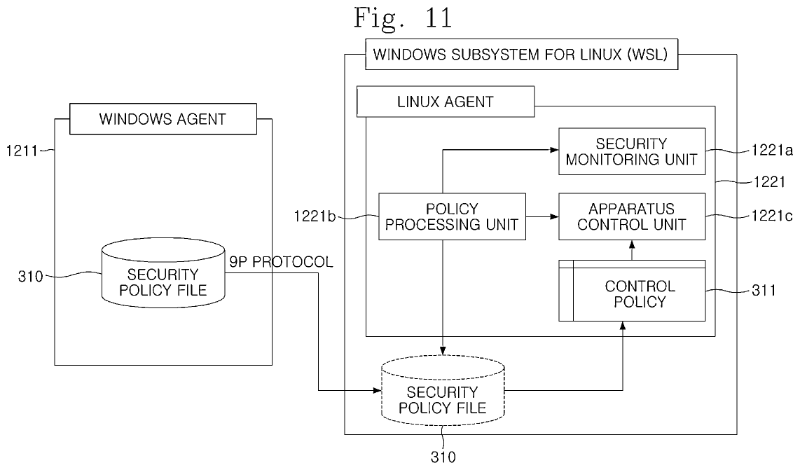

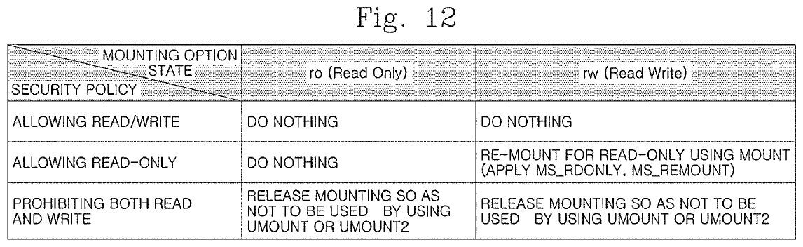

In addition, FIG. 11 illustrates a process of applying a security policy applied to the Windows agent corresponding to the first security agent 1211 to the Linux agent corresponding to the second security agent 1221 in the computing apparatus 200, such as the heterogeneous operating system device 120.

As shown in FIG. 11, the policy processing unit 1221b of the Linux agent may read the security policy file 310 of the Windows agent, which is mounted as driveFS using the 9p protocol based on the WSL and automatically shared, and may provide the security policy file 310 to the apparatus control unit 1221c, the security monitoring unit 1221a, and the like.

Here, since the security policy file 310 may be encrypted, in order to prevent excessive load during a decryption process, the policy processing unit 1221 may load the security policy when the Linux agent starts and then re-load same when a change occurs, while monitoring the security policy file 310.

The policy processing unit 1221 may notify the security monitoring unit 1221a and the apparatus control unit 1221c that the security policy file 310 has been changed so that a changed security policy is applied to the existing mounted file system.

Accordingly, s control unit 1221c may identify control target mounting items transferred from the security monitoring unit 1221a and perform a control operation, such as performing a log operation, changing a corresponding apparatus to be in an unusable state, and the like according to the control level of the control policy as shown in FIG. 12.

Here, the control policy may include three levels of authority including allowing read/write, allowing read-only, and prohibiting both read and write, and in case that an authority permitted by the policy is lower than an authority permitted for each apparatus, the control may be performed through mount( ), umount( ), umount2( ) which correspond to a mount-related UNIX API.

In addition, the computer program according to another aspect of the present disclosure is a computer program stored in a computer-readable medium for executing the series of operations of the security method for the heterogeneous operating system device 120 in the heterogeneous operating system device security system 100 described above in a computer. The computer program may include a computer program including high-level language code which may be executed on a computer using an interpreter as well as a computer program including machine code produced by a compiler. Here, the computer is not limited to a personal computer (PC) or a laptop, but includes any information processing apparatus equipped with a central processing unit (CPU) capable of executing computer programs, such as a server, a smartphone, a tablet PC, a PDA, and a mobile phone.

Furthermore, the computer-readable medium may continuously store a computer-executable program, or may be temporarily stored for execution or download. Furthermore, the medium may be various recording means or storage means in a form of a single or a combination of multiple hardware, may be not limited to a medium directly connected to any computer system, and may exist on a network while being dispersed. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

FIG. 9 illustrates an apparatus 200 to which the proposed method of the present disclosure may be applied.

Referring to FIG. 9, the apparatus 200 may be configured to implement a security process for the heterogeneous operating system device 120 in the heterogeneous operating system device security system 100 according to the proposed method of the present disclosure. By way of example, the apparatus 200 may correspond to the heterogeneous operating system device 120.

For example, the apparatus 200 to which the proposed method of the present disclosure may include a network device, such as a repeater, a hub, a bridge, a switch, a router, and a gateway, a computer apparatus, such as a desktop computer and a workstation, a mobile terminal, such as a smartphone, a portable device, such as a laptop computer, a home appliance, such as a digital TV, a transportation mean, such as a vehicle, and the like. For another example, the apparatus 200 to which the present disclosure may be applied may be included as a portion of an application specific integrated circuit (ASIC) realized in a system-on-chip (SoC) form.

The memory 20 may be operatively connected to the processor 10, store programs and/or instructions for processing and controlling of the processor 10, and store data and information used in the present disclosure, control information required for data and information processing according to the present disclosure, temporary data generated during a data and information processing process, and the like. The memory 20 may be realized as a storage apparatus, such as a read only memory (ROM), random access memory (RAM), an erasable programmable read only memory (EPROM), an electrically erasable programmable read-only memory (EEPROM), a flash memory, a static RAM (SRAM), a hard disk drive (HDD), and a solid state drive (SSD).

The processor 10 may be operatively connected to the memory 20 and/or the network interface 30 and controls an operation of each module in the apparatus 200. Specifically, the processor 10 may perform various control functions for performing the proposed method of the present disclosure. The processor 10 may be referred to as a controller, a microcontroller, microprocessor, a microcomputer, and the like. The proposed method of the present disclosure may be realized by hardware, firmware, software, or a combination thereof. In case that the present disclosure is realized using hardware, an application specific integrated circuit (ASIC) or a digital signal processor (DSP), a digital signal processing device (DSPD), a programmable logic device (PLD), a field programmable gate array (FPGA), and the like, which are configured to perform the present disclosure, may be included in the processor 10. In case that the proposed method of the present disclosure is realized using firmware or software, the firmware or the software may include instructions related to a module, procedure, or function configured to perform functions or operations required for realizing the proposed method of the disclosure, and the instructions may be stored in the memory 20 or in a computer-readable storage medium (not shown) separately from the memory 20 and configured to, when executed by the processor 10, cause the apparatus 200 to implement the proposed method of the present disclosure.

Furthermore, the apparatus 200 may include a network interface device 30. The network interface device 30 may be operatively connected to the processor 10, and the processor 10 may control the network interface device 30 to transmit or receive a wireless/wired signal carrying information and/or data, a signal, a message, and the like through a wireless/wired network. The network interface device 30 supports various communication standards, such as IEEE 802 series, 3GPP LTE(-A), 3GPP 5G, and the like, and may transmit and/or receive a control information and/or data signal in accordance with such communication standards. The network interface device 30 may be realized outside the apparatus 200, if necessary.

Accordingly, the method, the apparatus, the system, and the computer program for enhancing security of a heterogeneous operating system device according to an embodiment of the present disclosure may allow efficient security enhancement of the device driven on the basis of the heterogeneous operating system, allow a security policy, which is identical to a security policy applied to the host operating system 121, to be applied to the guest operating system 122, and allow the first security agent 1211 driven on the host operating system 121 to manage the second security agent 1221 driven on the guest operating system 122, and, if necessary, to automatically install or re-execute the second security agent 1221.

The embodiments and drawings described in the present specification are merely illustrative and do not restrict the scope of the present disclosure in any manner. In addition, the line connections or connecting elements between components illustrated in the drawings are examples of functional and/or physical or circuit connections, and in an actual apparatus, they may be substituted or represented by various additional functional, physical, or circuit connections. Furthermore, unless explicitly stated as “essential” or “important”, the component may not be necessary for the application of the present disclosure.

In the specification of the present disclosure (particularly in the claims), the use of the term “the” and similar directive terms may refer to both singular and plural. Furthermore, if a range is specified in the present disclosure, it includes an invention to which individual values within the range (unless otherwise stated) are applied, and it is considered equivalent to specifying each individual value constituting the range in the detailed description of the invention. In addition, the operations presented in the method of the present disclosure are not intended to impose a strict sequential order, and the order may be adjusted as required, unless a specific step must precede another based on the nature of each process. In the present disclosure, the use of all examples or exemplary terms (e.g., the like) is merely for the purpose of describing the present disclosure in detail, and the scope of the present disclosure is not limited by these examples or exemplary terms unless restricted by the claims. Furthermore, those skilled in the art will understand that various modifications, combinations, and changes may be made depending on design conditions and elements within the scope of the appended claims or their equivalents.

What is claimed is:

1. A security method for a computing apparatus in which a heterogeneous operating system operates, the method comprising:
collecting, by a first security agent driven in a host OS of the computing apparatus, guest OS information for a guest OS installed on the host OS; and
performing, by the first security agent, management for a second security agent driven on the guest OS on the basis of the guest OS information.

2. The method of claim 1, wherein the performing of management comprises:
receiving, by the first security agent, a periodic signal periodically transmitted from the second security agent; and
in case that the periodic signal is not received, performing, by the first security agent, a predetermined security operation for the guest OS.

3. The method of claim 2, wherein in the performing of the security operation, installation of the second security agent or re-execution of the second security agent is performed.

4. The method of claim 3, wherein the performing of the security operation comprises:
identifying a normal installation state verification history with respect to the second security agent;
in case that there is a normal installation state verification history of the second security agent, installing the second security agent, and in case that there is no normal installation state verification history of the second security agent, verifying a normal installation state of the second security agent; and
in case that the second security agent is normally installed, re-executing the second security agent, and in case that the second security agent is not normally installed, installing the second security agent.

5. The method of claim 1, wherein the performing of management comprises:
receiving, by the first security agent, second security log data for the guest OS, transmitted by the second security agent; and
generating integrated security log data on the basis of the second security log data and the first security log data for the host OS, and transmitting the generated integrated security data to a security server, by the first security agent.

6. The method of claim 1, wherein the second security agent receives and applies a security policy identical to a security policy applied to the first security agent.

7. The method of claim, wherein the first security agent performs a security process based on the host OS with respect to at least one information input/output apparatus provided to the computing apparatus, and
wherein the second security agent performs a security process based on the guest OS with respect to the at least one information input/output apparatus.

8. The method of claim 7, wherein the host OS corresponds to a Windows OS and the guest OS corresponds to a Linux OS driven on a WSL of the Windows OS, and
wherein the first security agent performs management for the second security agent by using an interface or a file sharing protocol provided by the WSL.

9. The method of claim 8, wherein the second security agent detects a mounting state change in the Linux OS by using a mounting information file of the Linux OS and performs a security process based on a security policy, on the basis of the detected mounting state change.

10. The method of claim 8, wherein the second security agent receives a security policy file from the first security agent by using a file sharing protocol provided by the WSL and applies the security policy file.

11. A computing apparatus for performing security with respect to an environment in which a heterogeneous operating system is driven, the computing apparatus comprising:
a processor; and
a memory,
wherein the memory comprises an instruction configured to, when executed by the processor, cause the computing apparatus to implement a predetermined operation, and
wherein the predetermined operation comprises:
collecting, by a first security agent driven in a host OS of the computing apparatus, guest OS information for a guest OS installed on the host OS; and
performing, by the first security agent, management for a second security agent driven on the guest OS, on the basis of the guest OS information.

12. The apparatus of claim 11, wherein the performing of management comprises:
receiving, by the first security agent, a periodic signal periodically transmitted from the second security agent; and
in case that the periodic signal is not received, performing, by the first security agent, a predetermined security operation for the guest OS.

13. The apparatus of claim 12, wherein the performing of the security operation comprises:
identifying a normal installation state verification history with respect to the second security agent;
in case that there is a normal installation state verification history of the second security agent, installing the second security agent, and in case that there is no normal installation state verification history of the second security agent, verifying a normal installation state of the second security agent; and
in case that the second security agent is normally installed, re-executing the second security agent, and in case that the second security agent is not normally installed, installing the second security agent.

14. The apparatus of claim 11, wherein the performing of management comprises:
receiving, by the first security agent, second security log data for the guest OS, transmitted by the second security agent; and
generating integrated security log data, on the basis of the second security log data and the first security log data for the host OS, and transmitting the generated integrated security log data to a security server, by the first security agent.

15. The apparatus of claim 11, wherein the second security agent receives and applies a security policy identical to a security policy applied to the first security agent.

16. The apparatus of claim 11, wherein the first security agent performs a security process based on the host OS with respect to at least one information input/output apparatus provided to the computing apparatus, and
wherein the second security agent performs a security process based on the guest OS with respect to the at least one information input/output apparatus.

17. The apparatus of claim 16, wherein the host OS corresponds to a Windows OS and the guest OS corresponds to a Linux OS driven on a WSL of the Windows OS, and
wherein the first security agent performs management for the second security agent by using an interface or a file sharing protocol provided by the WSL.

18. The apparatus of claim 17, wherein the second security agent detects a mounting state change in the Linux OS by using a mounting information file of the Linux OS and performs a security process based on a security policy, on the basis of the detected mounting state change.

19. The apparatus of claim 17, wherein the second security agent receives a security policy file from the first security agent by using a file sharing protocol provided by the WSL and applies the security policy file.

20. A computer-readable storage medium storing instructions configured to, when executed by a processor, cause a computing apparatus to perform a predetermined operation, the computing apparatus including the processor and being configured to perform security with respect to an environment in which a heterogeneous operating system is driven,
wherein the predetermined operation comprises:
collecting, by a first security agent driven in a host OS of the computing apparatus, guest OS information for a guest OS installed on the host OS; and
performing, by the first security agent, management for a second security agent driven on the guest OS, on the basis of the guest OS information.
